(19) United States
(12) Patent Application Publication
(10) Pub. No.: US 2010/0073695 A1
(43) Pub. Date: Mar. 25, 2010

(54) METHODS AND SYSTEMS FOR INCREASING PERFORMANCE OF SERVER-BASED RENDERING

(75) Inventors: Angus Duggan, Seattle, WA (US); Jonathan R. Wilson, Cambridge (GB)

Correspondence Address: DARBY & DARBY P.C., P.O. BOX 770, Church Street Station, New York, NY, 10008-0770, US

(73) Assignee: Global Graphics Software Limited, Cambridge (GB)

(21) Appl. No.: 12/426,107

(22) Filed: Apr. 17, 2009

Related U.S. Application Data
(60) Provisional application No. 61/046,095, filed on Apr. 18, 2008.

(51) Int. Cl. G06F 3/12; G06T 1/00; G06F 15/00

(52) U.S. Cl. 358/1.6; 345/501; 358/1.13

(57) ABSTRACT

Methods, devices, and systems for printing include a raster image processor that has a central processing unit (CPU) to decode graphical elements from a page description language (PDL); and a graphic processing unit (GPU) that is separate from, and coupled to, the CPU and renders the decoded graphical elements from the CPU into a raster.

### CROSS REFERENCE TO RELATED APPLICATION

This application claims the benefit of U.S. Provisional Patent Application Ser. No. 61/046,095, filed Apr. 18, 2008, the entire contents of which is incorporated by reference.

### BACKGROUND

Professional printing devices such as plate-setters for offset lithography or digital production presses are driven by RIPs (raster image processors) running on servers (often called digital front ends or DFEs). The performance required by a DFE is dependent on many factors, including the number of pages per minute that it must produce to allow any associated marking engine to run at its rated speed, and the amount of raster data required by each page. The amount of raster data for each page is, in turn, dependent on the page size, the resolution of the raster (often measured in dots per inch) and the number of color channels.

RIPs in DFEs are software programs running on more-or-less standard central processing units (CPUs). The RIP reads the job description, supplied in a page description language (PDL) such as PostScript, the Adobe Portable Document Format (PDF), Microsoft's eXtensible Paper Specification (XPS) or Advanced Function Presentation/Intelligent Printer Data Stream (AFP/IPDS). The RIP converts this data into a raster representation that is suitable for delivery to the imaging heads on the device that it is configured to drive.

In some cases, especially when driving digital production presses, specialist hardware pipelines (using, for example, one or more FPGAs (field programmable gate arrays), ASICs (application specific integrated circuits) or DSPs (digital signal processors)) are used to post-process the raster that is created by the RIP, e.g. to color manage the data into the color space of the print device, to apply halftone screening, or to stitch multiple rasters together into a whole page image. As a software solution the performance of RIPs will tend to rise more or less in line with increases in CPU speed, which is more or less in accordance with Moore's Law, plus whatever else can be achieved by further manual optimization of code.

Printing devices, especially digital production presses, are increasing in page rate, resolution and color channels faster than the normal improvement in server performance can keep pace with. Therefore additional methods can be applied so that DFEs can drive the printing devices at engine speed on a high proportion of printing jobs.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic overview of one embodiment of a printing system, according to the invention; and

FIG. 2 is a schematic block diagram of one embodiment of a raster image processor, according to the invention.

### DETAILED DESCRIPTION

The methods, systems, and devices described herein may be embodied in many different forms and should not be construed as limited to the embodiments set forth herein. The following detailed description is, therefore, not to be taken in a limiting sense.

Suitable computing devices typically include mass memory and typically include communication between devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Methods of communication can include both wired and wireless (e.g., RF, optical, or infrared) communications methods and such methods provide another type of computer readable media; namely communication media. Communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes buses on a computer motherboard or within a hybrid computer processor die that contains both CPU and GPU cores, wired media such as twisted pair, coaxial cable, fiber optics, wave guides, and other wired media and wireless media such as acoustic, RF, infrared, and other wireless media.

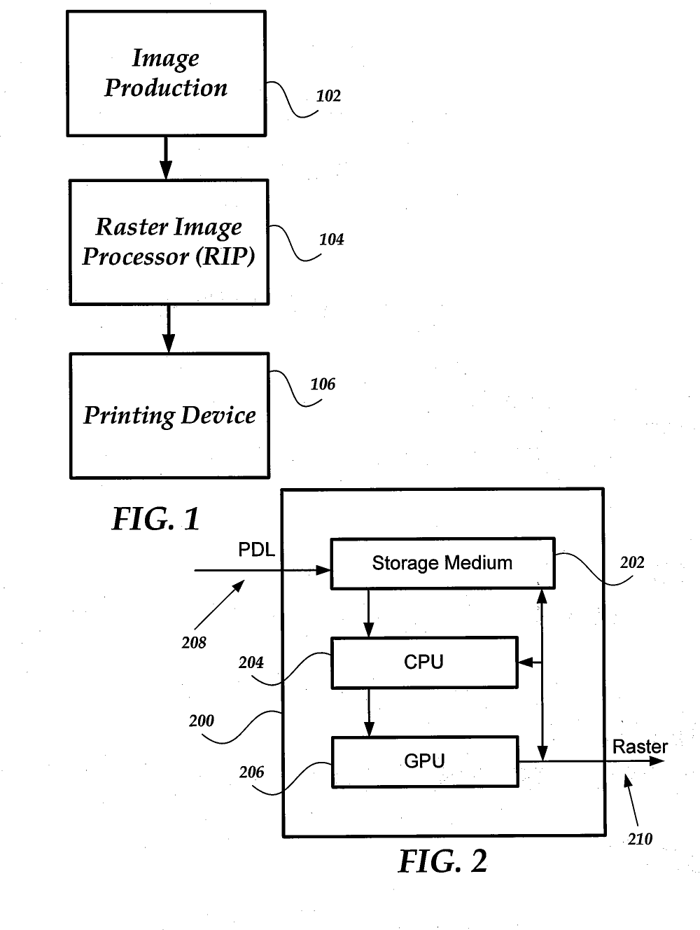

One example of an arrangement for printing is schematically illustrated in FIG. 1. Each of the components in FIG. 1 can be achieved using hardware, software, or a combination thereof. In addition, the individual components can be separate or combined with one or more of the other illustrated components into a single device. For example, the image production system 102 and raster image processor (RIP) 104 can be combined on a single computer or the raster image processor 104 can be provided on a computer that controls a printing device 106 or different portions of the raster image processor 104 may be on the image production system 102 and printing device 106 (or even a stand-alone device). The components, individually or in any combination, can include, but are not limited to, a processor, a memory unit, and optionally an input unit. The memory unit can be any suitable storage device selected from removable and non-removable storage devices including, but not limited to, a hard drive, a diskette, a compact disc, a memory stick, random access memory, and the like. The input unit can be any suitable device for inputting information into the component including, but not limited to, a keyboard, mouse, touch-screen, disk drive, memory stick, compact disk drive, and the like.

An image production system 102 produces, procures, or otherwise prepares data (e.g., images, text, photos, graphics, and the like) for printing. The data can be provided as a digital file in any suitable format including, but not limited to, a byte map, or a file in PDL (or other) format. The data is provided to a raster image processor 104 which processes the data to form one or more rasters as described above.

The raster image processor 104 provides the raster(s) to a printing device 106 which then prints the data. The raster(s) can be provided to the printing device as they are being generated, or with a delay, or when the raster(s) are complete. Raster(s) can be provided for each ink of a printing device separately or the rasters of one or more colors can be combined into a single raster using, for example, an interleaved format. When individual rasters for each color are provided to the printing device, these rasters can be provided sequentially or simultaneously (for example, using interleaved or parallel delivery.) The rasters (for example, a page or other object) can be printed on a medium such as, for example, paper, foil, plastic, fabric, metal, wood, ceramic, and the like. The rasters can be printed by any printing method including, but not limited to, ink jet printing, laser printing, flexographic printing, lithographic printing, gravure printing, screen printing, pad printing, and the like.

To date the prime use of GPUs (Graphic Processing Units) has been for rendering for computer monitors. In comparison with printing, computer monitors are very low resolution, are driven in RGB and in 8-bit-per-pixel-per-colorant contone, while print work is usually in Black or CMYK and often uses additional spot colors or process color models with more colorants for a wider gamut. Rasters for printing may be halftoned, (resulting in the data being 1-bit per pixel per colorant), may use variable depth screening (resulting in 2 or 4 bits per pixel per colorant), or may be delivered by the RIP in contone (usually in 8 or 10 bits per pixel per colorant) for later post-processing.

Rasters for display on monitors are delivered in a standard color space, such as sRGB, while print work is typically delivered in a device-specific color space to match the requirements of the combination of printing engine, colorants (inks, toners, etc), media (paper, plastic, etc), print resolution, halftone screening, and the like. Thus the final color management applied in a print workflow is typically configurable to account for printing on a variety of substrate media, and potentially other factors.

In the past the video frame rate used to drive monitors has been much higher than the page rate for print jobs. Recent print engine developments now mean that these two rates are very similar (for example, a recent digital press launched in 2008 by Hewlett-Packard prints at over 40 pages per second).

Finally, GPUs for monitors are typically optimized to render from three dimensional data onto a two dimensional monitor, while the page description languages (PDLs) (such as Adobe PostScript, Hewlett Packard's Printer Control Language (PCL) and Microsoft's XML Paper Specification (XPS)) rendered for print by a RIP are all 2D and are rendered to the 2D paper or other 2D medium. The following table summarizes these features.

| | | | Color | Frame/page | Input |
|---|---|---|---|---|---|
| | Resolution | Color space | depth | rate | optimization |
| Monitor | Low (60-150 dpi) | RGB | 8 bits per | 50-100 | 3D to 2D |
| | | | pixel per | frames per | |
| | | | colorant | second | |
| | | | (i.e. 24 bit | | |
| | | | for the 3 | | |
| | | | RGB | | |
| | | | channels) | | |
| Print | Medium to | Black, CMYK, | 1, 2, 4, 8, | Up to 45 | 2D to 2D |
| | high (300-5000 dpi) | rich process | 10, 12 etc | pages per | |
| | | color spaces | bits per | second | |
| | | (such as | pixel per | | |
| | | Hexachrome), | colorant. | | |
| | | optionally plus | | | |
| | | spot colors | | | |

Historically, GPUs have been primarily mounted on video cards and tuned specifically for that use. One aspect of that tuning is that there is typically a high-speed data pathway from the CPU on the mother board to the GPU on a video card to deliver data that is to be rendered into raster data, but the pathway for the raster data to be returned only has the same bandwidth, while the raster for a high-resolution print device is often much larger than the original PDL. When rendering for a monitor the raster data is transmitted directly from the video card to the monitor, without a need for it to be accessible to other system components. Thus a GPU on a video card may not be suitable for use in a print system as the rendered data cannot be recovered at a high enough speed.

Specialist video cards can be quite expensive, relative to the cost of a computer for home and office use, but many applications and features of operating systems have developed to the point where some effects cannot be reasonably shown on the monitor without some form of GPU support. As a result some GPU and computer manufacturers are developing GPUs designed to be mounted on the motherboard of the computer itself. These can be significantly cheaper than a specialist video card, especially when supporting motherboard-mounted video (as opposed to having a separate video card at all). While such arrangements will often not satisfy hard-core garners (the market that drives innovation in video cards), they do offer the opportunity for a significant step forward for the industry as a whole.

Moreover, the CPU and GPU can be implemented in a hybrid or ‘fusion’ computer processor die that includes both CPU and GPU cores. A GPU mounted on the motherboard or included in a hybrid processor die may be accessed by applications for other uses in addition to driving the monitor. One such use would be to assist with rendering of pages for print.

It should be noted that GPUs are significantly different from field-programmable gate arrays (FPGAs) and application-specific integrated circuits (ASICs) in a number of ways including cost, availability, convenience of inclusion in server-based solutions running on common PC hardware and mode of use.

As a general rule a CPU is designed to enable very complex sets of instructions, allowing for a program to respond flexibly to variations in the data that it is required to process. Programming of software for use on a CPU is typically relatively easy and extremely sophisticated tools are widely available for the majority of CPUs in widespread use in current desktop computers. On the other hand, a GPU is designed to perform very large numbers of relatively simple, repetitive tasks at very high speed with less flexibility to alter the way in which data is handled once processing is initiated. Programming a GPU for anything but a very simple, repetitive task is an extremely complex operation for which sophisticated tools are not available.

Thus a CPU may be used to perform a task such as interpreting a PDL efficiently, where the same task might be too complex for a GPU to perform at all, or the development of a solution to perform that task on a GPU may be unfeasibly expensive. On the other hand, a GPU will often be able to perform a simple task that must be repeated many millions of times (such as applying color management, halftoning data and the like) far more quickly than a CPU.

FIG. 2 illustrates one embodiment of an RIP 200 that includes a storage medium 202, central processing unit (CPU) 204, and graphic processing unit (GPU) 206. Data 208 in a PDL (or other) format is provided to the RIP. The data is processed by the CPU and GPU and output as a raster 210. As indicated above, the RIP 200 can be part of a computing device or image production device, part of a printing device, or a separate stand-alone device, or can be distributed among any combination of these devices.

The RIP process is separated into two components. The first component includes interpretation of the supplied PDL. It runs on the computer CPU in the same way as a normal server-based RIP. The first component sends representations of all of the graphical elements decoded from the PDL in a standardized and simplified form to a second component. Examples of such forms are discussed in U.S. Provisional Patent Application Ser. No. 61/046,274 and U.S. patent application Ser. No. ______, entitled “Methods, Devices, and Systems for Encoding Graphical Primitives, Attorney Docket No. 03002/1209513-US1, filed on even date herewith, both of which are incorporated by reference.

The second component runs on a GPU and renders the graphical element representations to a raster image. This differs significantly from the use of a GPU for rendering of video signals. For example, the GPU may work in multiple color spaces (the ability to re-configure the implementation between multiple spaces, including, for instance Black and CMYK is different from typical video applications). Additional spaces such as Hexachrome, or support for spot colors can also be provided.

Additionally or alternatively, the GPU may work on substantially larger raster dimensions than are typical for computer monitors. (For example, a ‘large’ monitor raster is of the order of 1920×1200 pixels, while a moderate size platesetter may run at 32″×42″ and 2540 dpi, leading to pixel dimensions of 100000×80000. Even a cut-sheet digital production press outputting letter-sized pages may be running at 800 dpi, giving pixel dimensions of 6800×8800).

Additionally or alternatively, the GPU may deliver halftone screened data, rather than contone (in at least some circumstances). When half-toning, different screens may be used for each colorant, and it is advantageous to be able to screen different objects differently, as may be requested in PostScript and PDF.

Additional print-specific activity may be processed through the GPU, including color management and trapping. Just as in video rendering, multiple GPUs may be used concurrently to increase performance still further.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A raster image processor, comprising:
a central processing unit (CPU) configured and arranged to decode graphical elements from a page description language (PDL); and
a graphic processing unit (GPU) that is separate from, and coupled to, the CPU and configured and arranged to render the decoded graphical elements from the CPU into a raster.

2. The raster image processor of claim 1, wherein the GPU is disposed on a video card.

3. The raster image processor of claim 1, wherein the GPU is disposed on a motherboard with the CPU.

4. The raster image processor of claim 1, wherein the GPU is also configured and arranged for providing images to a monitor.

5. The raster image processor of claim 1, wherein the raster image processor further comprises a housing with the CPU and GPU disposed within the housing.

6. The raster image processor of claim 1, further comprising a storage medium coupled to the CPU.

7. The raster image processor of claim 1, wherein the GPU is disposed as a core in a hybrid processor die together with the CPU.

8. A printing system, comprising:
a raster image processor comprising
a central processing unit (CPU) configured and arranged to decode graphical elements from a page description language (PDL), and
a graphic processing unit (GPU) that is separate from, and coupled to, the CPU and configured and arranged to render the decoded graphical elements from the CPU into a raster; and
a printing device coupled to the raster image processor and configured and arranged to print the raster.

9. The printing system of claim 8, wherein the raster image processor is part of the printing device.

10. The printing system of claim 8, further comprising an image production system coupled to the raster image processor and configured and arranged to provide the graphical elements encoded in the PDL to the raster image processor.

11. The printing system of claim 8, further comprising a monitor coupled to the GPU and configured and arranged to display the raster from the GPU.

12. The printing system of claim 8, wherein the raster image processor further comprises a storage medium coupled to the CPU.

13. The printing system of claim 8, wherein the GPU is disposed on a video card.

14. The printing system of claim 8, wherein the GPU is disposed on a motherboard with the CPU.

15. The printing system of claim 8, wherein the raster image processor further comprises a housing with the CPU and GPU disposed within the housing.

16. The printing system of claim 8, wherein the GPU is disposed as a core in a hybrid processor die together with the CPU.

17. A method of printing, comprising:
providing a plurality of graphical elements to a raster image processor, wherein the graphical elements are encoded in a page description language (PDL);
decoding the graphical elements from the PDL using a central processing unit (CPU) of the raster image processor;
rendering a raster of the decoded graphical elements using a graphic processing unit (GPU) of the raster image processor; and
printing the raster.

18. The method of printing of claim 17, further comprising displaying the raster on a monitor coupled to the GPU.

19. The method of claim 17, wherein the GPU is disposed as a core in a hybrid processor die together with the CPU.
